(19) United States
(12) Patent Application Publication
(10) Pub. No.: US 2015/0007786 A1
(43) Pub. Date: Jan. 8, 2015

(54) FUEL SUPPLY APPARATUS OF INTERNAL COMBUSTION ENGINE

(71) Applicant: SUZUKI MOTOR CORPORATION, Hamamatsu-shi (JP)

(72) Inventor: Koichiro KAWATA, Hamamatsu-shi (JP)

(73) Assignee: SUZUKI MOTOR CORPORATION, Hamamatsu-shi (JP)

(21) Appl. No.: 14/322,349

(22) Filed: Jul. 2, 2014

(30) Foreign Application Priority Data
Jul. 3, 2013 (JP) 2013-139886

(51) Int. Cl. F02M 35/16; F02M 55/02; F02M 35/10; F02M 39/00; F02B 61/02; F02B 75/18

(52) U.S. Cl. CPC F02M 35/162; F02B 61/02; F02B 75/18; F02M 35/10288; F02M 39/00; F02M 55/02
USPC 123/52.1

(57) ABSTRACT

A secondary injector that is one of a plurality of injectors provided for each cylinder is arranged in an air cleaner and above an air funnel, an air cleaner bottom plate that has a passage hole for forming an intake passage is fastened and fixed to an upper surface of a throttle body, and the air funnel and a pipe support post for a secondary delivery pipe are fastened and fixed to the air cleaner bottom plate.

### CROSS-REFERENCE TO RELATED APPLICATIONS

This application is based upon and claims the benefit of priority of the prior Japanese Patent Application No. 2013-139886, filed on Jul. 3, 2013, the entire contents of which are incorporated herein by reference.

### BACKGROUND OF THE INVENTION

1. Field of the Invention

The present invention typically relates to a fuel supply apparatus of an internal combustion engine in a motorcycle and the like in which a parallel multicylinder engine is mounted.

2. Description of the Related Art

In a motorcycle equipped with an engine with a large lateral width such as a parallel four-cylinder engine or the like, a throttle body, a secondary injector and an air cleaner and so on surrounding them are arranged at an upper part of the engine.

For example, Patent Document 1 discloses an example in which a fuel injection device (secondary injector) is attached to an upper case of the air cleaner in the motorcycle of the above type. In this example, in the case of attaching the secondary injector to an air cleaner upper lid, the attachment of the secondary injector is made possible just by adding a cover member.
[Patent Document 1] Japanese Laid-open Patent Publication No. 2010-19200

However, in the conventional apparatus as described above, the secondary injector is attached via an air cleaner body, resulting in deterioration in positional accuracy of a fuel line (fuel supply passage). Further, since the position of the secondary injector is decided in a state that the air cleaner upper lid is assembled, the attachment state of the secondary injector cannot be confirmed.

Furthermore, since the distance from the throttle body to the secondary injector has been decided, the shape of the air cleaner upper lid is limited, and it is difficult to cope with the case when the height of an air box is desired to be increased. Further, the attachment surface (protruding surface) of the secondary injector is formed inside the air cleaner, thus causing not only a problem of failing to secure a large air cleaner capacity but also a problem of decreasing the engine output because of a large intake resistance.

### SUMMARY OF THE INVENTION

Under consideration of the above circumstances, an object of the present invention is to provide a fuel supply apparatus of an internal combustion engine capable of effectively improving the intake performance and so on while ensuring a high positional accuracy of members.

A fuel supply apparatus of an internal combustion engine of the present invention in which a throttle body is arranged in a vertical posture in an intake passage that links an air cleaner arranged above a parallel multicylinder engine to an engine combustion chamber, the fuel supply apparatus includes: an injector that injects fuel and an air funnel which are provided in the intake passage; a secondary injector that is one of a plurality of the injectors provided for each cylinder and arranged in the air cleaner and above the air funnel; a secondary delivery pipe and a pipe support post therefor, wherein an air cleaner bottom plate that has a passage hole for forming the intake passage is fastened and fixed to an upper surface of the throttle body, and wherein the air funnel and the pipe support post for the secondary delivery pipe are fastened and fixed to the air cleaner bottom plate.

Further, in the fuel supply apparatus of an internal combustion engine of the present, wherein the pipe support post is arranged at almost a middle between adjacent cylinders, and a fastening part for the air funnel is provided at a position opposite to the pipe support post at least with respect to intake passage center axes of the cylinders, and wherein the fastening part is set inside an opening portion in an upper surface of an air cleaner body in a top view.

Further, in the fuel supply apparatus of an internal combustion engine of the present invention, the secondary injector is mounted and supported on an upper surface of the pipe support post via the secondary delivery pipe.

### BRIEF DESCRIPTION OF THE DRAWINGS

FIG. 1 is a side view of a motorcycle according to an embodiment of the present invention;

FIG. 2 is a side view in a state that an engine unit and an air cleaner are mounted on a vehicle frame in the embodiment of the present invention;

FIG. 3 is a top view in a state that the engine unit and the air cleaner are mounted on the vehicle frame in the embodiment of the present invention;

FIG. 4A is a cross-sectional view taken along a I-I line in FIG. 2;

FIG. 4B is an enlarged view of an X part in FIG. 4A;

FIG. 5 is a cross-sectional view taken along a II-II line in FIG. 3;

FIG. 6 is an exploded perspective view of the air cleaner when bottom plates and so on are attached in the embodiment of the present invention;

FIG. 7 is an exploded perspective view of the air cleaner when the bottom plates and so on are detached in the embodiment of the present invention;

FIG. 8 is a perspective view illustrating an assembly process of the air cleaner and so on in the embodiment of the present invention;

FIG. 9 is an exploded perspective view of the air cleaner and so on mounted on the vehicle frame in the embodiment of the present invention;

FIG. 10A is a left side view illustrating a schematic configuration of a fuel supply apparatus in the embodiment of the present invention;

FIG. 10B is a right side view illustrating the schematic configuration of the fuel supply apparatus in the embodiment of the present invention;

FIG. 11 is a broken perspective view illustrating a configuration example of the fuel supply apparatus inside the air cleaner in the embodiment of the present invention;

FIG. 12 is a longitudinal sectional view in a rear view illustrating a configuration example of the fuel supply apparatus inside the air cleaner in the embodiment of the present invention;

FIG. 13 is a rear perspective view illustrating a support structure example for air funnels and a secondary delivery pipe in the embodiment of the present invention;

FIG. 14A is a rear perspective view illustrating the support structure example for the air funnels and the secondary delivery pipe at the air cleaner bottom plate on the right side in the embodiment of the present invention;

FIG. 14B is a top view illustrating the support structure example for the air funnels and the secondary delivery pipe at the air cleaner bottom plate on the right side in the embodiment of the present invention; and

FIG. 15 is a top view when an air cleaner upper lid relating to the fuel supply apparatus in the embodiment of the present invention is detached.

### DETAILED DESCRIPTION OF THE PREFERRED EMBODIMENTS

Hereinafter, a preferred embodiment of a fuel supply apparatus of an internal combustion engine in the present invention will be described on the basis of the drawings.

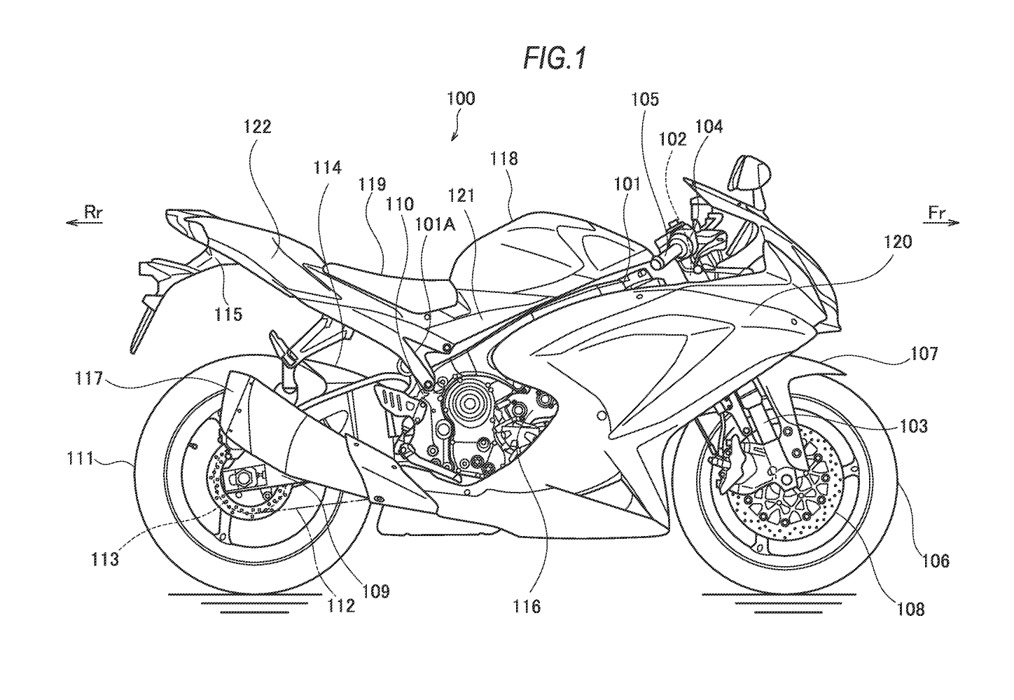

FIG. 1 is a side view of a motorcycle 100 as an application example of the present invention. First, an entire structure of the motorcycle 100 will be described using FIG. 1. Note that in the drawings including FIG. 1 used in the following explanation, as necessary, the front of a vehicle is indicated by an arrow Fr and the rear of the vehicle is indicated by an arrow Rr, and a lateral right side of the vehicle is indicated by an arrow R, and a lateral left side of the vehicle is indicated by an arrow L.

In FIG. 1, at front parts of a vehicle frame 101 (main frame) 101 made of steel or an aluminum alloy material, two right and left front forks 103 are provided that are supported to be turnable right and left by means of a steering head pipe 102. A handle bar 104 is fixed to upper ends of the front forks 103, and grips 105 are provided at both ends of the handle bar 104. A front wheel 106 is rotatably supported on lower portions of the front forks 103, and a front fender 107 is fixed at the lower portions of the front forks 103 so as to cover an upper portion of the front wheel 106. The front wheel 106 has a brake disk 108 that rotates integrally with the front wheel 106.

The vehicle frame 101 are integrally connected with a rear part of the steering head pipe 102 and branched rearward into a two-pronged shape of a right and left pair, and extend from the steering head pipe 102 while widening downward and rearward. In this example, the vehicle frame 101 is a so-called twin spar frame which is employed as a preferable one in a vehicle required to have a high-speed performance. Note that a seat rail 101A extends inclining properly to rise rearward from the vicinity of the rear part of the vehicle frame 101 and supports a later-described seat. Further, a swing arm 109 is swingably coupled to a rear part of the vehicle frame 101, and a rear shock absorber 110 is laid between them. A rear wheel 111 is rotatably supported on a rear end of the swing arm 109. The rear wheel 111 is configured to be rotationally driven via a driven sprocket 113 around which a chain 112 that transmits motive power of a later-described engine is wound. An inner fender 114 that covers the vicinity of a front upper portion of the rear wheel 111 is provided closely around the rear wheel 111, and a rear fender 115 may be disposed above the inner fender 114.

An air-fuel mixture made by mixing air and fuel supplied from not-illustrated air cleaner and fuel supply apparatus (these will be described later) respectively is supplied to an engine unit 116 mounted on the vehicle frame 101, and an exhaust gas after combustion in the engine passes through an exhaust pipe and is exhausted from a muffler 117. A fuel tank is mounted above the engine unit 116, and the fuel tank is covered with a tank cover 118. A seat 119 is provided continuously to the rear of the fuel tank.

As for the exterior of the vehicle, a fairing 120 and side cowls 121 mainly cover a front part and side parts of the vehicle, and a side cover or a seat cowl 122 is attached to a rear part of the vehicle, so that those exterior members form an external appearance form of the vehicle having a so-called streamline shape.

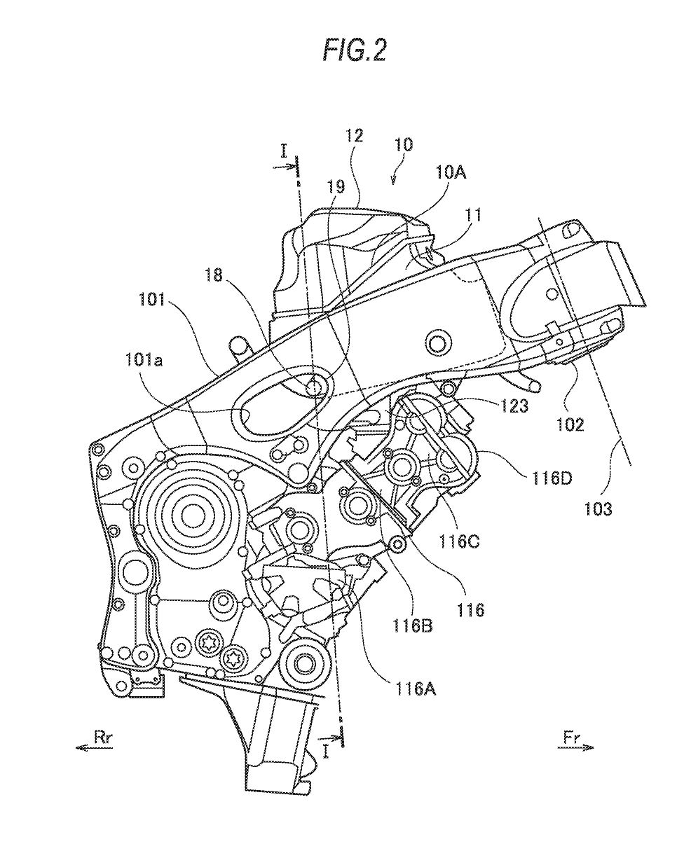

In this embodiment, the engine of the engine unit 116 may be, for example, a four-cycle multicylinder, typically, a parallel four-cylinder engine. Here, the engine unit 116 in this embodiment is configured such that a cylinder block 116B, a cylinder head 116C and a cylinder head cover 116D are integrally coupled in sequence on an upper part of a crankcase 116A as illustrated in FIG. 2. Further, the engine unit 116 is suspended from the vehicle frame 101 via a plurality of engine mounts and thereby integrally coupled to and supported by the vehicle frame 101 and functions as a rigid member of the vehicle frame 101 in itself.

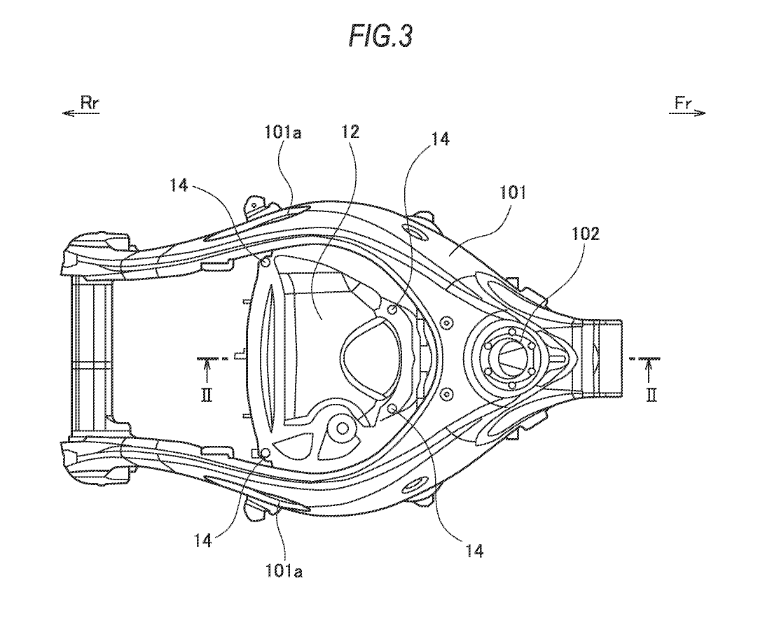

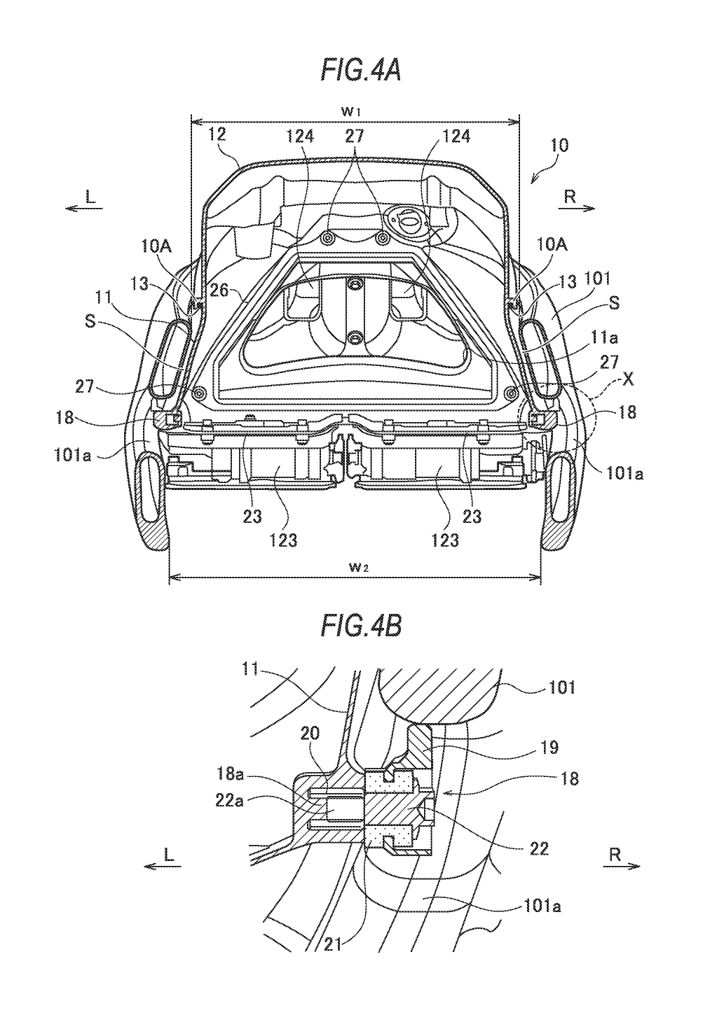

In FIG. 2 and FIG. 3, the right and left pair of vehicle frame 101 extend from the steering head pipe 102 slightly downward to the rear. As illustrated in FIG. 3, the width between right and left inner surfaces of the vehicle frame 101 smoothly and gradually increases rearward from the steering head pipe 102 as illustrated in FIG. 3, and thus has an interspace or a space typically, though partially, forming an egg shape or a water drop shape. The vehicle frame 101 has a top-bottom direction width that is substantially the same as an axial length of the steering head pipe 102 as illustrated in FIG. 2. In this case, the vehicle frame 101 are formed to be smaller in width at the upper side than at the lower surface side as illustrated in FIG. 4A, namely, to be in an inverted V-shape with the upper surfaces thereof narrowed inward. In short, the vehicle frame 101 are configured such that an inner width w₁ on the upper surface side is set to be smaller than an inner width w₂ on the lower surface side in the vehicle width direction.

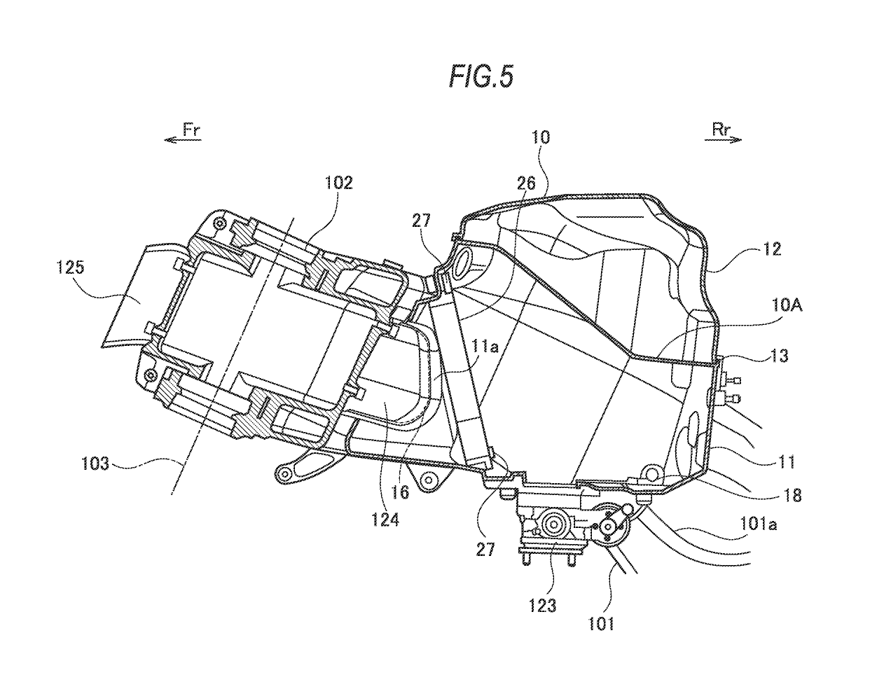

In the interspace or space formed between the right and left vehicle frame 101 having the above-described form, an air cleaner 10 is housed and arranged as in FIG. 4A and FIG. 5 and so on. The air cleaner 10 and the engine unit 116, in particular, the cylinder head 116C are connected by throttle bodies constituting intake devices. Air cleaned by the air cleaner 10 is taken in by the intake devices and the fuel is supplied from the fuel supply apparatus, whereby the air-fuel mixture at a predetermined mixture ratio is fed to an intake port of the cylinder head 116C. As is clear also from FIG. 2, the air cleaner 10 is located above the cylinder head 116C. In an intake passage that links an engine combustion chamber communicating with the intake port to the air cleaner 10, throttle bodies 123 are arranged in a vertical posture in the substantially vertical direction as illustrated in FIG. 2 or FIG. 5, namely, this embodiment has a down draft type intake structure.

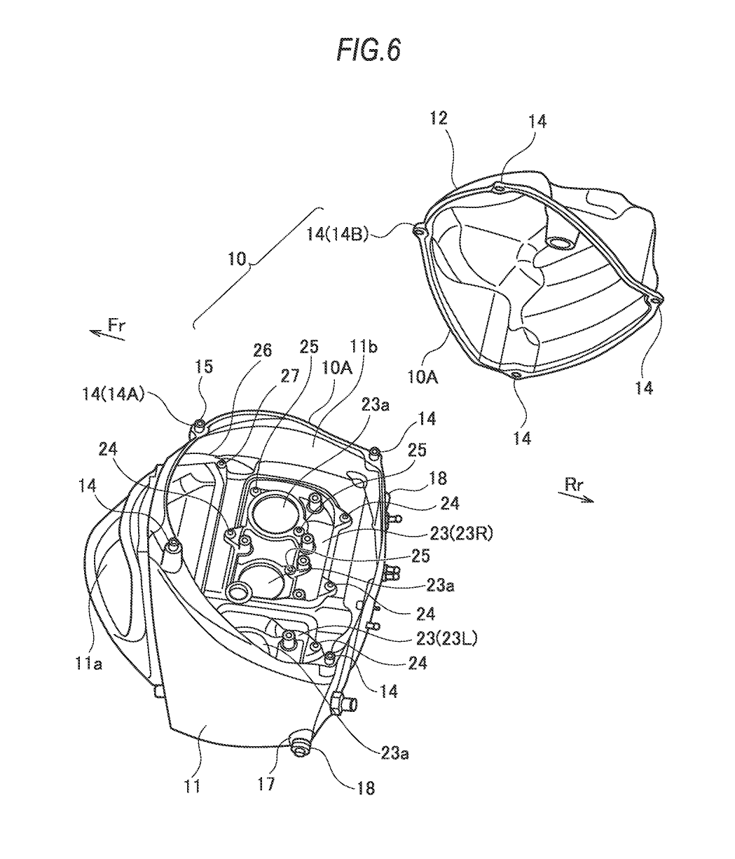

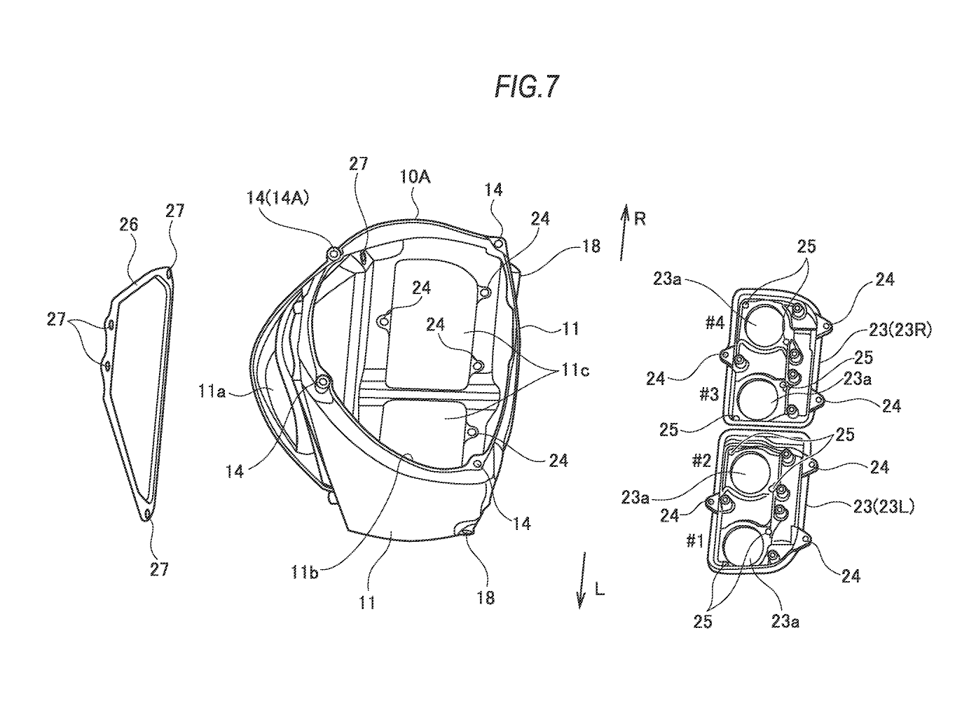

Here, FIG. 6 and FIG. 7 illustrate a concrete configuration example of the air cleaner 10 in this embodiment. The air cleaner 10 includes an air cleaner body 11 and an air cleaner upper lid 12 which are divided into two upper and lower halves, both of which are combined into one body to form an almost deformed box shape. The front surface, the upper surface and the bottom surface of the air cleaner body 11 are provided with opening portions 11a, 11b and 11c respectively. To the opening portion 11b in the upper surface, among them, of the air cleaner body 11, a seal member 13 (FIG. 5) is attached and the air cleaner upper lid 12 is mounted, and both of them are fastened with bolts to close the opening portion 11b. In this case, the air cleaner 10 has a plurality of (four in this example) fastening parts 14 whose fastening bosses 14A are formed at the air cleaner body 11 and thus has threaded portions into which bolts 15 are screwed as illustrated in FIG. 6 and FIG. 7. Further, on the air cleaner upper lid 12, fastening flange portions 14B are projectingly provided and have openings into which the bolts 15 are inserted. Fastening the four fastening parts 14 firmly couple the air cleaner body 11 and the air cleaner upper lid 12.

The opening portion 11a in the front surface of the air cleaner body 11 is formed to be long in the right-left direction as illustrated in FIG. 4A so that air is introduced into the opening portion 11a from intake ducts 124 illustrated in FIG. 4A and FIG. 5 and so on. In other words, the opening portion 11a in the front surface is configured as an air introduction port. As illustrated in FIG. 5, an intake port 125 communicating with the intake ducts 124 is opened at a front part of the steering head pipe 102. The intake ducts 124 communicating with the intake port 125 are routed around from both right and left sides of the steering head pipe 102 and joined together at the rear part thereof, and connected to the opening portion 11a of the air cleaner body 11. The opening portion 11a of the air cleaner body 11 is inserted into the intake ducts 124 via rubber seals 16 being seal members and fixed in a floating manner as illustrated in FIG. 5.

Further, as illustrated in FIG. 6 and so on, the air cleaner 10 has a right and left pair of fastening parts 18 to the vehicle frame 101 at lower corner parts 17 (only the one on the left side of the right and left pair is illustrated in FIG. 6) near the rear end on the outside surface of the air cleaner body 11, and is supported, at the fastening parts 18, in a floating manner by fastening brackets 19 (see FIG. 2) projectingly provided on the vehicle frame 101. More specifically, the fastening bracket 19 extends in a window part 101a formed in the vehicle frame 101 as illustrated in FIG. 2, and the fastening bracket 19 projects from the window part 101a in a side view. FIG. 4B illustrates a detailed structure of the fastening part 18, in which an insert nut 20 is embedded in the fastening part 18. To the fastening bracket 19, a cushion 21 is attached, and a fastening bolt 22 inserted in the cushion 21 is screwed together with the insert nut 20. In this case, a threaded portion 22a of the bolt 22 comes into contact with a seat 18a provided in the fastening part 18 and thereby fastens the cushion 21 with an appropriate force amount and supports the fastening part 18 without backlash.

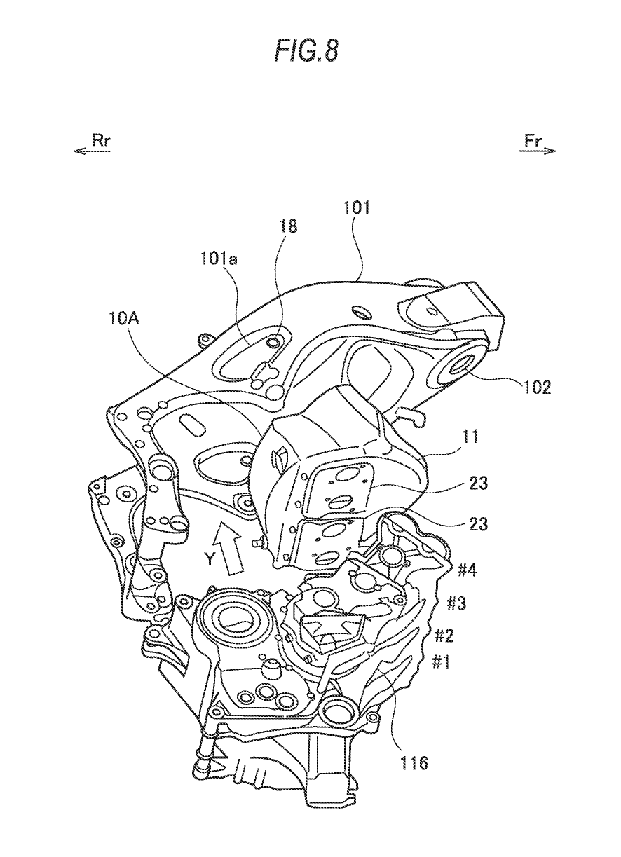

As illustrated in FIG. 6 and FIG. 7, in the opening portions 11c in the bottom surface of the air cleaner body 11, air cleaner bottom plates 23 are fastened to the air cleaner body 11 via seal members. In the parallel four-cylinder engine in this embodiment, #1 to #4 cylinders (note that simply described as “#1” and so on in the following description) are arranged from the left in the right-left (vehicle width) direction (see FIG. 8). Though the throttle body 123 is connected to each of the cylinders, adjacent throttle bodies in combination are coupled together via a bracket and formed into a unit. In other words, the four throttle bodies 123 are divided into two blocks such as a set of #1 and #2 and a set of #3 and #4. The air cleaner 10 has the two left and right opening portions 11c for an air cleaner bottom plate 23L corresponding to #1 and #2 and an air cleaner bottom plate 23R corresponding to #3 and #4. Each of the air cleaner bottom plates 23 uses bolts as fastening means and is fastened to the air cleaner body 11 at three fastening parts 24 in this example.

In each of the air cleaner bottom plates 23, passage holes 23a that link the engine combustion chamber to the inside of the air cleaner body 11 are formed so that the intake air flows via the passage holes 23a. Each of the air cleaner bottom plates 23 is further fastened to the corresponding throttle body 123 at two fastening parts 25 in this example set near the outer peripheral portion of the passage hole 23a for each throttle body 123. Also at the fastening parts 25, bolts are used as fastening means. As illustrated in FIG. 4A and FIG. 5, the air cleaner body 11 is coupled to the upper end portions of the throttle bodies 123, and the air cleaner bottom plates 23 are directly coupled to the throttle bodies 123, and the passage holes 23a are arranged to align with the intake passages of the throttle bodies 123.

Further referring to FIG. 6 and FIG. 7, an air filter 26 is attached between the opening portion 11a in the front surface of the air cleaner body 11 and the opening portions 11c in the bottom surface, obliquely directed in the direction of the opening portion 11b being a substantially upper surface. The air filter 26 is formed in a mound shape, namely, to be narrower on the upper portion side as illustrated in FIG. 4A and so on, and fastened to the air cleaner body 11 at four fastening parts 27 in this example. Also at the fastening parts 27, bolts are used as fastening means.

In the above case, a not-illustrated fuel tank is mounted and supported on the rear side of the air cleaner 10 mounted on the vehicle frame 101. The fuel tank and the air cleaner 10 are integrally covered with a tank cover 118 as a whole.

Further, the shape of a portion of the air cleaner body 11 overlapping with the vehicle frame 101 in a side view in FIG. 2, namely, arranged inside the vehicle frame 101 as illustrated in FIG. 4A is formed such that the upper surface portion is narrower than the bottom surface portion. In this case, substantially uniform gaps S are formed along and between the outside surface of the air cleaner body 11 and the inner surfaces of the vehicle frame 101. Further, the air cleaner upper lid 12 coupled to the opening portion 11b in the upper surface of the air cleaner body 11 has a planar shape equal to or less than the opening portion 11b as is found from FIG. 4A or FIG. 6 or the like. In other words, the whole air cleaner 10 is formed to fit inside the inner width between the right and left portions of the vehicle frame 101.

Here, the air cleaner body 11 is inserted from below (namely, the wider side of) the vehicle frame 101 (an arrow Y in FIG. 8) before the engine unit 116 is mounted, and fixed to the vehicle frame 101 in assembly of the air cleaner 10 and so on as illustrated in FIG. 8. The air cleaner body 11 is set to be narrower on its upper surface side and to ensure the gaps S with respect to the inner surfaces of the vehicle frame 101, and therefore can be effortlessly and appropriately inserted and assembled to the vehicle frame 101 being the twin spar frame.

The twin spar frame reduces the frontal projected area of the vehicle and thereby improves the aerodynamic performance. The twin spar frame further enhances the degree of freedom at riding of a rider to improve the riding property, thereby making it possible to provide the motorcycle 100 equipped with the wide parallel multicylinder engine while improving both the aerodynamic performance and the riding property.

Further, twist, horizontal and longitudinal stiffness adjustment of the vehicle frame 101 can be easily performed depending on the characteristics of the vehicle (performance requirement).

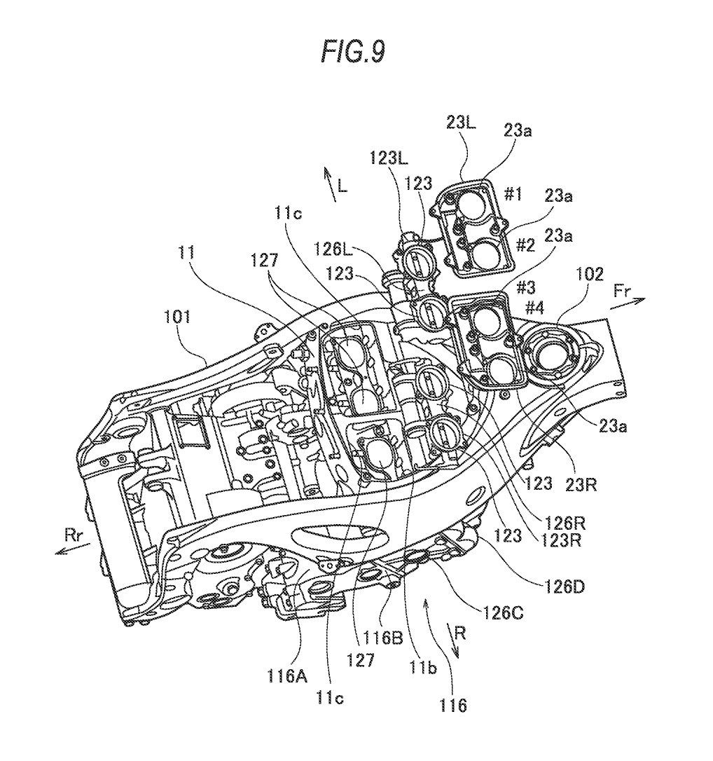

Further referring to FIG. 9, the throttle bodies 123 of #1 and #2 corresponding to the air cleaner bottom plate 23L are coupled together via a bracket 126L into a unit (assumed as a throttle body 123L). The lower end side of the throttle body 123L is connected to intake ports 127 of #1 and #2 communicating with the engine combustion chamber at the cylinder head 116C. Further, the throttle bodies 123 of #3 and #4 corresponding to the air cleaner bottom plate 23R are coupled together via a bracket 126R into a unit (assumed as a throttle body 123R). The lower end side of the throttle body 123R is similarly connected to intake ports 127 of #3 and #4.

The throttle bodies 123 can be attached to and detached from the intake ports 127. The left and right opening portions 11c of the air cleaner body 11 corresponding to the throttle body 123L and the throttle body 123R have shapes and dimensions required for the throttle body 123L and the throttle body 123R to pass therethrough.

As described above, the front surface, the upper surface and the bottom surface of the air cleaner body 11 are provided with opening portions 11a, 11b and 11c respectively. To the opening portion 11b in the upper surface, among them, of the air cleaner body 11, the seal member 13 (FIG. 5) is attached and the air cleaner upper lid 12 is mounted, and both of them are fastened with bolts to close the opening portion 11b.

When detaching the air cleaner upper lid 12, the bolts 15 in the fastening parts 14 are accessed from above and loosened, whereby the air cleaner upper lid 12 can be easily detached. This opens the inside of the air cleaner body 11 and enables a maintenance work and so on to be easily and smoothly performed in this state. In short, the air cleaner upper lid 12 functions as a so-called maintenance cap and can greatly improve the maintenability.

Further, the air cleaner bottom plates 23 having the passage holes 23a are fastened to the opening portions 11c in the bottom surface of the air cleaner body 11.

Removing the air cleaner bottom plates 23 opens the opening portions 11c in the bottom surface to expose the throttle body 123L and the throttle body 123R in the left and right opening portions 11c respectively. The throttle body 123L and the throttle body 123R can be taken out through the left and right opening portions 11c respectively. As described above, it is unnecessary to remove the air cleaner body 11 and detach the engine unit 116 from the vehicle frame 101 in order to detach the throttle bodies 123 sandwiched between the engine side and the air cleaner body 11.

Further, the throttle bodies 123 are divided in a predetermined combination, and the air cleaner bottom plates 23 and the opening portions 11c corresponding thereto are also divided.

In this example, the air cleaner bottom plates 23 and the throttle bodies 123 are divided into two right and left blocks, thereby making it possible to attach and detach the components such as the throttle body 123L and the throttle body 123R even with a relatively small opening portion 11b in the upper surface of the air cleaner body 11. The air cleaner body 11, if formed to be in a shape (with a cross section of an inverted V-shape) with the upper portion thereof narrowed conforming to the vehicle frame 101, ensures excellent component attachability and detachability and exhibit a high effect when it is applied to the twin spar frame.

Note that in the case where the shape of the air cleaner body 11 is not narrowed upward, there is substantially no problem even if the air cleaner bottom plates 23 and the throttle bodies 123 are not divided into two blocks.

Further, the air cleaner bottom plates 23 are fastened to the throttle bodies 123 fixed to the engine side, whereby the engine and the air cleaner body 11 are integrally fixed. This ensures the positional and dimensional accuracies of the passage holes 23a that link the engine combustion chamber to the air cleaner body 11 to ensure the excellent intake performance.

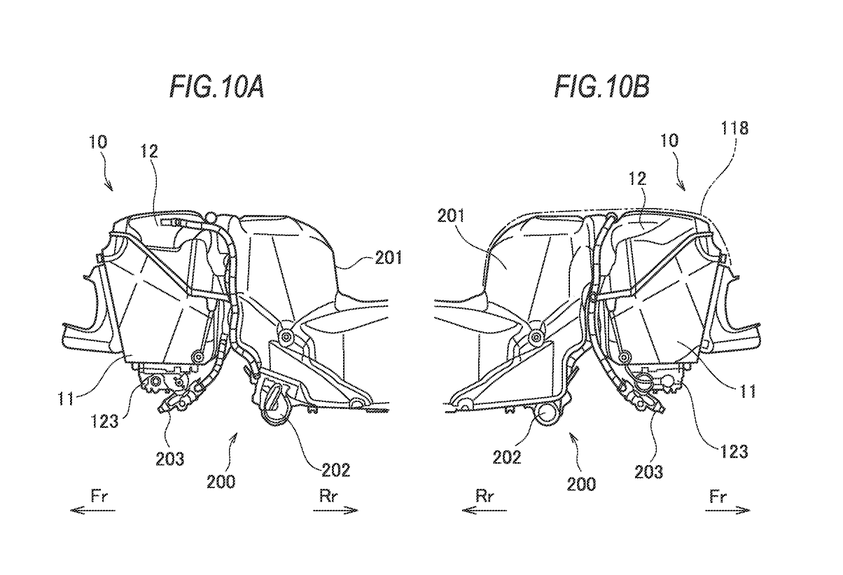

Incidentally, the fuel supply apparatus of the present invention is typically applied to the engine unit 116 being the internal combustion engine together with the above-described air cleaner 10. FIG. 10A, FIG. 10B illustrate a schematic configuration of a fuel supply apparatus 200 in this embodiment. In the fuel supply apparatus 200, a fuel tank 201 is arranged adjacent on a vehicle rear of the air cleaner 10, and a fuel pump 202 is attached to the lower surface of the fuel tank 201. In this embodiment, two kinds of injectors that inject fuel to an intake system are provided, namely, each cylinder has a plurality of injectors composed of a primary injector and a secondary injector. Among them, the primary injector 203 is arranged on the downstream of a throttle valve attached to the throttle body 123 as illustrated in FIG. 10A, FIG. 10B, and the secondary injector is housed and arranged in the air cleaner 10 as will be described later. The fuel pump 202 and the injector and so on are connected by a fuel pipe so that the fuel discharged from the fuel pump 202 is supplied via the fuel pipe to the primary injector 203 and so on. Note that the air cleaner 10 and the fuel tank 201 are integrally covered with the tank cover 118 (also see FIG. 1) as roughly illustrated in FIG. 10B.

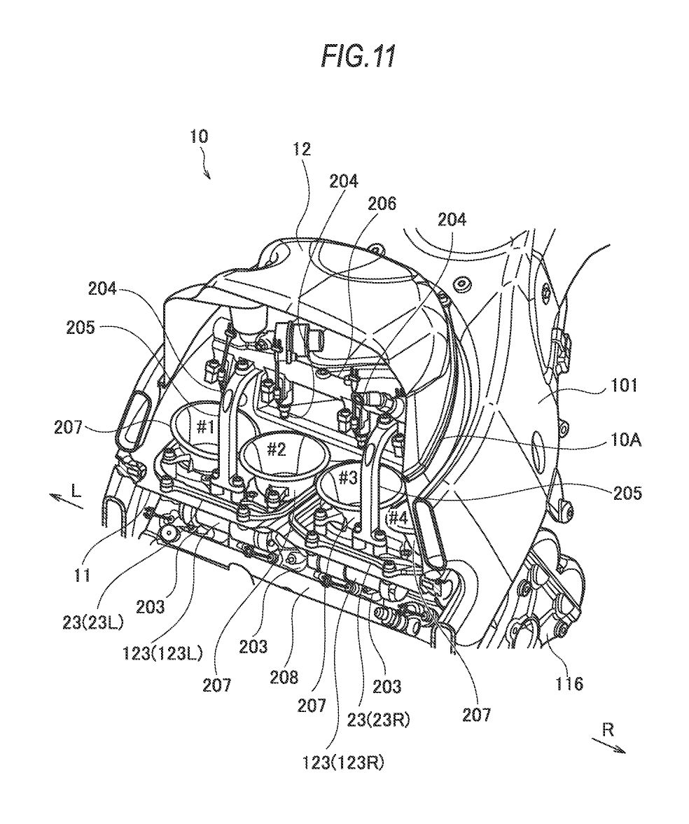

Here, components such as the secondary injectors 204 and so on are arranged inside the air cleaner 10 as illustrated in FIG. 11. The secondary injector 204 is provided for each of the #1 to #4 cylinders, in which case the four secondary injectors 204 are mounted and supported along a secondary delivery pipe 206 laterally bridged in the vehicle width direction via a pair of pipe support posts 205. Each of the pipe support posts 205 is fastened to a predetermined region of the air cleaner bottom plate 23 (23R, 23L) and supports the secondary delivery pipe 206 at its tip end projectingly provided to overhang forward as illustrated in the drawing though its concrete fastening structure will be described later. Each of the secondary injectors 204 is attached above a later-described air funnel with its injection port directed downward so as to inject the fuel supplied from the secondary delivery pipe 206.

Further, an air funnel 207 is provided for each of the #1 to #4 cylinders, and each air funnel 207 is fastened to a predetermined region of the air cleaner bottom plate 23 (23R, 23L) in a manner to be aligned and communicate with the passage hole 23a of the corresponding air cleaner bottom plate 23. Note that the four air funnels 207 are arranged in the vehicle width direction at substantially the same pitch as the pitch between the cylinders. The air funnel 207 takes in air in the air cleaner 10 from the upper opening expanding in diameter in a horn shape, and the air is supplied to the throttle body 123 via the passage hole 23a. For each cylinder, the secondary injector 204 is arranged above the air funnel 207.

Further, a primary delivery pipe 208 is laterally bridged in the vehicle width direction as illustrated in FIG. 11 obliquely below the rear of the throttle bodies 123. Along the primary delivery pipe 208, the four primary injectors 203 are mounted and supported at the same pitch as the pitch between the cylinders. The primary delivery pipe 208 is connected to the fuel pump 202 via the fuel pipe and is supplied with the fuel.

The secondary injector 204 that is one of the plurality of injectors provided for each cylinder is arranged above the air funnel 207 inside the air cleaner 10, and the secondary injector 204 and the air funnel 207 corresponding thereto are arranged to be inclined such that the base portion of the secondary injector 204 on the outer side in the vehicle width direction is biased to the center side in the vehicle width direction and its injection port is directed to the throttle body 123.

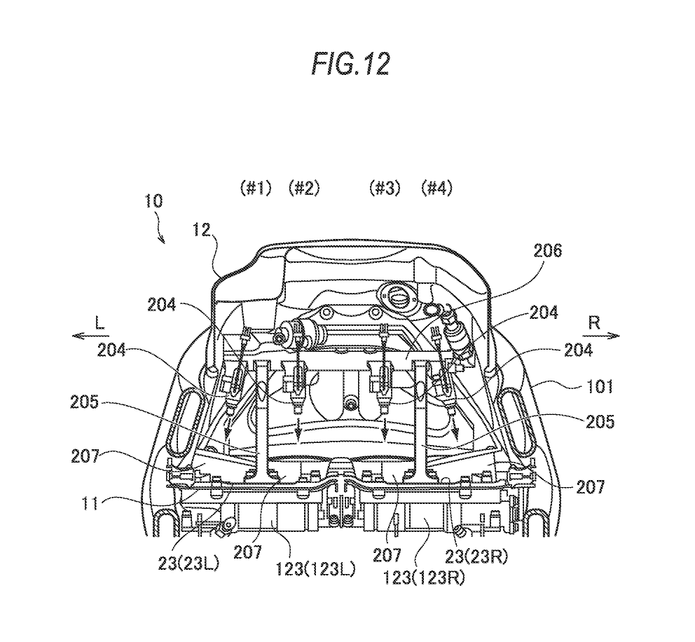

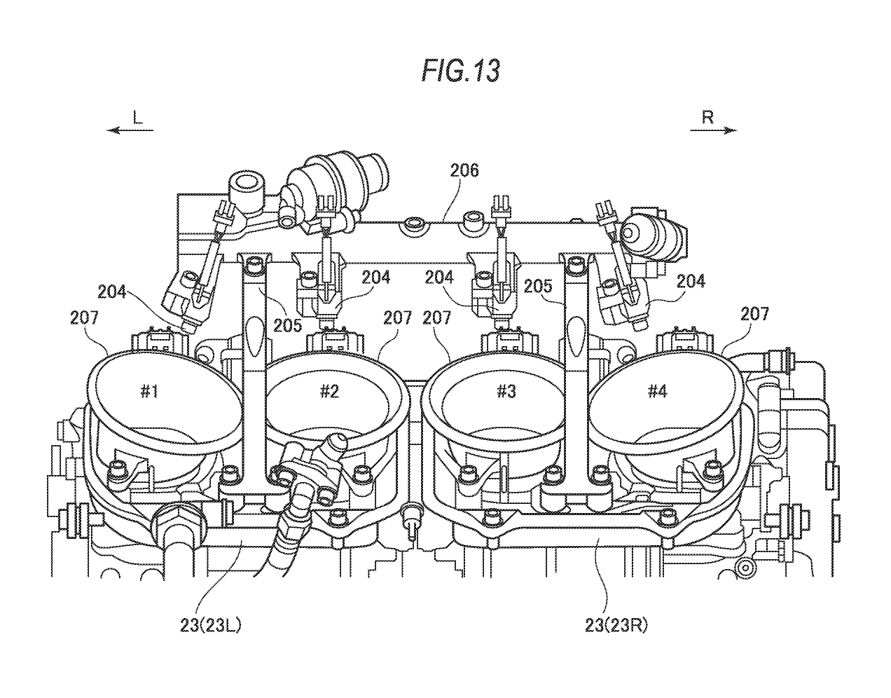

More specifically, the secondary injector 204 of #1 is inclined with respect to the vertical direction such that its injection port side is biased leftward and the air funnel 207 of #1 facing the secondary injector 204 is inclined with respect to the vertical direction such that its upper open side is biased rightward as illustrated in FIG. 12 or FIG. 13. In this case, the axes of the secondary injector 204 and the air funnel 207 substantially coincide with each other. Further, the secondary injector 204 of #4 is inclined with respect to the vertical direction such that its injection port side is biased rightward and the air funnel 207 of #4 facing the secondary injector 204 is inclined with respect to the vertical direction such that its upper open side is biased leftward. In this case, the axes of the secondary injector 204 and the air funnel 207 substantially coincide with each other. Note that the secondary injectors 204 of #2 and #3 and the air funnels 207 facing them are not inclined but substantially directed in the vertical direction.

As for the main flow of a fuel supply system composed of the fuel supply apparatus 200 according to this embodiment, first, the fuel pump 202 sucks the fuel in the fuel tank 201, and the fuel discharged from the fuel pump 202 is supplied to the primary injectors 203 via the primary delivery pipe 208. Concurrently therewith, the fuel is discharged from the primary delivery pipe 208 to the secondary delivery pipe 206, and supplied to the secondary injectors 204 via the secondary delivery pipe 206. Thereafter, the fuel is returned from the secondary delivery pipe 206 to the fuel pump 202, and further to the fuel tank 201.

In the present invention, in particular, the air funnels 207 and the pipe support posts 205 for the secondary delivery pipe 206 are fastened and supported to the respective air cleaner bottom plates 23. As illustrated in FIG. 13, the secondary delivery pipe 206 is supported via the right and left pair of pipe support posts 205. In this example, the left and right pipe support posts 205 are erected from the air cleaner bottom plate 23L and the air cleaner bottom plate 23R respectively as illustrated in the drawing.

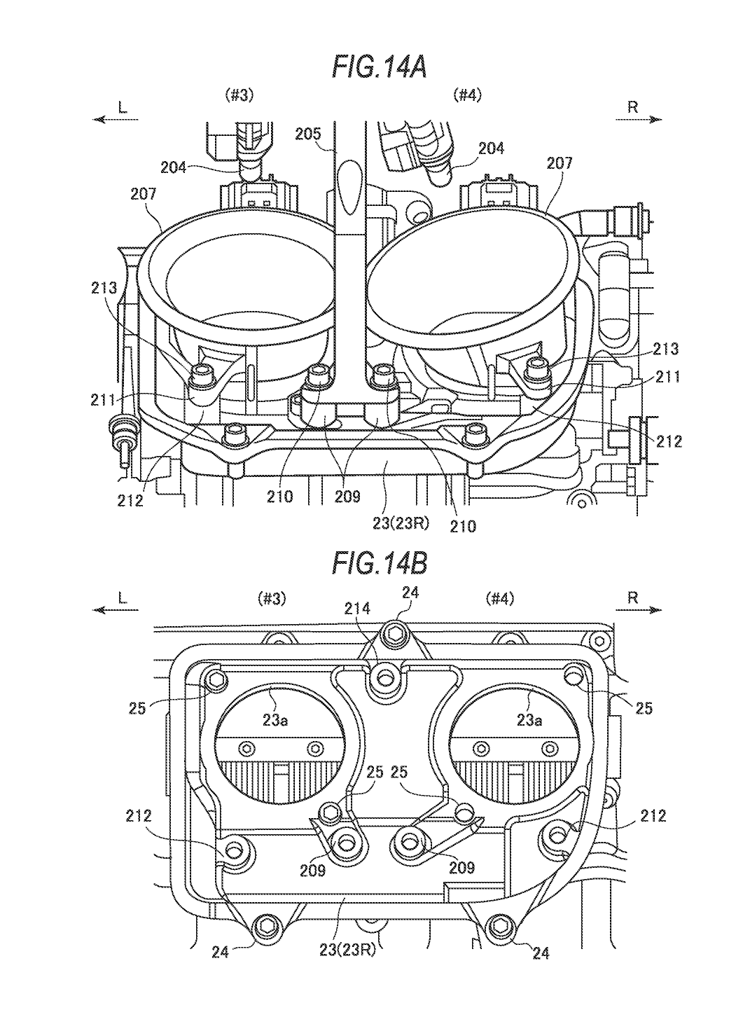

Referring to FIG. 14A, FIG. 14B, the example of the air cleaner bottom plate 23R on the right side will be described. FIG. 14A illustrates a state that the air funnel 207 and the pipe support post 205 are attached at the air cleaner bottom plate 23R, and FIG. 14B illustrates a state that they are detached. The pipe support post 205 has a base potion extending to both right and left sides as illustrated in FIG. 14A, and has a vertically inverted T shape. To correspond to the extending portions, a pair of fastening parts 209 are arranged to be located in a region at a rear of the passage holes 23a of the adjacent #3 and #4 cylinders and almost between the right and left passage holes 23a at the air cleaner bottom plate 23R as illustrated in FIG. 14B. Note that since the upper opening side of the air funnel 207 of #4 is tilts to the left side as described above, the fastening parts 209 are arranged appropriately closer to the passage hole 23a of #3. The pipe support post 205 has the base portion fastened and fixed to the fastening parts 209 by a pair of bolts 210 and is thereby erected at almost the middle between #3 and #4 and closer to the rear of the air funnels 207.

As illustrate in FIG. 14A, for the air funnels 207 of #3 and #4, brackets 211 are projectingly provided to extend from their outer side walls to the obliquely left rear and the obliquely right rear. Correspondingly to these brackets 211, fastening parts 212 are arranged at the obliquely left rear and the obliquely right rear of the passage holes 23a of #3 and #4 at the air cleaner bottom plate 23R respectively as illustrated in FIG. 14B. Each of the brackets 211 is fastened and fixed to the fastening part 212 with a bolt 213.

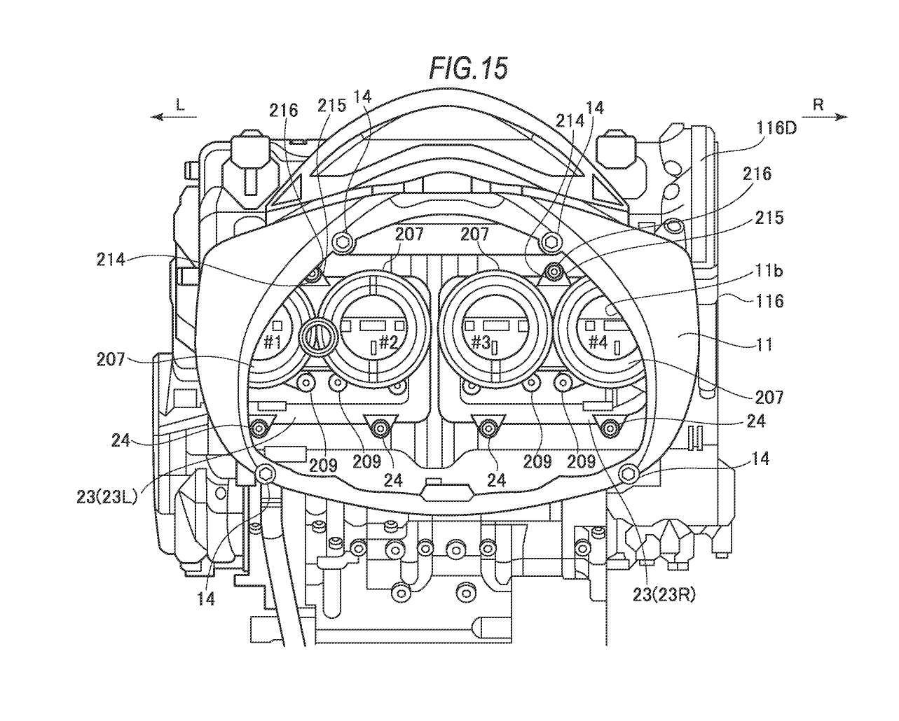

In addition to the fastening parts 212, a fastening part 214 is provided at a position opposite to the fastening parts 209 for the pipe support post 205 with respect to intake passage center axes of the #3 and #4 cylinders, namely, the passage holes 23a as illustrated in FIG. 14B. The fastening part 214 is located at almost the middle between #3 and #4 and closer to the front of the air funnels 207. On the other hand, correspondingly to the fastening part 214, brackets are projectingly provided to extend from the outer side walls of the air funnels 207 of 3 and #4 toward the obliquely right front and the obliquely left front though not illustrated in FIG. 14A. These brackets are fastened and fixed together to the fastening part 214 with a bolt. In FIG. 15, the respective bracket 215 of the air funnels 207 of 3 and #4 is fastened to the fastening part 214 with a bolt 216. As illustrated in FIG. 15, members around the fastening parts 212 and the fastening part 214 are installed inside the opening portion 11b in the upper surface of the air cleaner body 11 in a top view.

Though the above configuration is the example of the air cleaner bottom plate 23R on the right side, the air cleaner bottom plate 23L on the left side is similarly configured if the right-and-left relation is inverted to the above.

Further, as illustrated in FIG. 13 and so on, the four secondary injectors 204 of #1 to #4 are mounted and supported on the upper surface of the right and left pair of pipe support posts 205 via the secondary delivery pipe 206.

Next, main operation and effect of the fuel supply apparatus 200 of the present invention will be described. First, since the air cleaner bottom plates 23 are directly fixed to the throttle bodies 123, high positional accuracy thereof is ensured. Since the air funnels 207 and the pipe support posts 205 for the secondary injectors 204 are assembled to the air cleaner bottom plates 23, the positional accuracy thereof is also high. By enhancing the positional accuracy and support stiffness of the secondary injectors 204 and the air funnels 207, the positional accuracy from the injection ports of the secondary injectors 204 to the engine intake valve is improved to realize appropriate air-fuel mixture supply and ensure stable travel performance.

Further, since the air cleaner bottom plates 23 support the secondary injectors 204 via the pipe support posts 205, namely, the secondary injectors 204 are not attached to the air cleaner upper lid 12, the degree of freedom of the shape of the air cleaner 10 can be increased. In this case, there is no protruding shape to the inside of the air cleaner 10 on the constitution surface of the air cleaner upper lid 12, so that a large capacity of the air cleaner 10 can be ensured. Further, since the intake resistance is decreased, intake flow becomes smooth to improve the engine output.

Furthermore, the fastening part 214 for the air funnels 207 is provided at the position opposite to the fastening parts 209 for the pipe support post 205 with respect to the intake passage center axes. Setting and arranging the fastening of the members as described above provides a mounting structure with good balance. In this case, the members around the fastening parts 209 for the pipe support posts 205 and the fastening parts 214 for the air funnels 207 are arranged at positions viewed from the opening portion 11b in the upper surface of the air cleaner body 11 (FIG. 15). This makes it possible to remove the air cleaner upper lid 12 to easily access from above, leading to excellent assembly performance.

Further, the secondary delivery pipe 206 and the secondary injectors 204 are supported and fixed to the air cleaner bottom plates 23 via the pipe support posts 205. This makes it possible to properly confirm the mounting status of the devices inside the air cleaner 10, leading to excellent assembly performance and maintenability of the components and members.

The present invention has been described together with various embodiments hereinabove, but the present invention is not limited only to the embodiments but may be modified within the scope of the present invention.

In the above embodiment, the pipe support posts 205 for the secondary delivery pipe 206 can also be integrally formed with the secondary delivery pipe 206.

Further, the engine unit 116 is similarly applicable to a multicylinder engine other than the four cylinders, namely, for example, parallel six cylinders. In this case, six throttle bodies 123 and so on can be divided into three blocks such as a set of #1 and #2, a set of #3 and $4, and a set of #5 and #6.

According to the present invention, an air funnel and a secondary injector are attached to a cleaner bottom plate to enhance the positional accuracy and support stiffness thereof. Further, the positional accuracy from an injection port of the secondary injector to an engine intake valve is improved to realize appropriate air-fuel mixture supply and ensure stable travel performance.

It should be noted that the above embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

What is claimed is:

1. A fuel supply apparatus of an internal combustion engine in which a throttle body is arranged in a vertical posture in an intake passage that links an air cleaner arranged above a parallel multicylinder engine to an engine combustion chamber, the fuel supply apparatus comprising:
an injector that injects fuel and an air funnel which are provided in the intake passage;
a secondary injector that is one of a plurality of the injectors provided for each cylinder and arranged in the air cleaner and above the air funnel;
a secondary delivery pipe and a pipe support post therefor,
wherein an air cleaner bottom plate that has a passage hole for forming the intake passage is fastened and fixed to an upper surface of the throttle body, and
wherein the air funnel and the pipe support post for the secondary delivery pipe are fastened and fixed to the air cleaner bottom plate.

2. The fuel supply apparatus of an internal combustion engine according to claim 1,
wherein the pipe support post is arranged at almost a middle between adjacent cylinders, and a fastening part for the air funnel is provided at a position opposite to the pipe support post at least with respect to intake passage center axes of the cylinders, and
wherein the fastening part is set inside an opening portion in an upper surface of an air cleaner body in a top view.

3. The fuel supply apparatus of an internal combustion engine according to claim 1,
wherein the secondary injector is mounted and supported on an upper surface of the pipe support post via the secondary delivery pipe.

4. The fuel supply apparatus of an internal combustion engine according to claim 2,
wherein the secondary injector is mounted and supported on an upper surface of the pipe support post via the secondary delivery pipe.
